(19) United States
(12) Patent Application Publication
(10) Pub. No.: US 2025/0335824 A1
(43) Pub. Date: Oct. 30, 2025

(54) INFORMATION PROCESSING APPARATUS AND CONTROL METHOD THEREOF

(71) Applicant: CANON KABUSHIKI KAISHA, Tokyo (JP)

(72) Inventor: Ichiko MAYUZUMI, Kanagawa (JP)

(21) Appl. No.: 19/184,306

(22) Filed: Apr. 21, 2025

(30) Foreign Application Priority Data
Apr. 24, 2024 (JP) 2024-070814

(51) Int. Cl. G06N 20/00

(52) U.S. Cl. CPC G06N 20/00

(57) ABSTRACT

An information processing apparatus manages, in association with a first learning model, information on a second learning model used for creation of the first learning model and information on a first data set used for creation of the first learning model; and manages, in association with the first data set, information on a second data set used for creation of the first data set. The apparatus detects that a third learning model created by relearning on the second learning model has been added or that a third data set created by data manipulation on the second data set has been added; sets a notification condition for notifying that the third learning model or the third data set has been added; and performs notification if the set notification condition is satisfied.

### BACKGROUND OF THE INVENTION

### Field of the Invention

The present invention relates to a management technique of a learning model and a learning data.

### Description of the Related Art

In recent years, systems using machine learning techniques have been put to practical use in various fields. Known learning models and learning data used in such systems have been often created by companies, universities, and the like. However, in recent years, it has also become possible for a general user to create a learning model or learning data for the user's own purpose. For this reason, there are an enormous number of learning models and learning data.

A service via the Internet that can release and acquire learning models and learning data created by general users is assumed. A user who uses the service (e.g., a user who desires to create a customized model) needs to select a learning model or learning data suitable for the user's own purpose from among released learning models and learning data. However, when even a general user can create and release a learning model, an enormous number of learning models and learning data exist, which are to be updated daily. Therefore, it is difficult for the user who uses the service to grasp the status of the learning model and the learning data.

Japanese Patent Laid-Open No. 2022-178892 (Patent Document 1) discloses a method of searching for and finding target learning data based on a tag applied to learning data. Japanese Patent Laid-Open No. 2022-61191 (Patent Document 2) discloses a method of newly outputting an inference result and notifying a user of the result when a saved learning model is updated.

However, with the technique described in Patent Document 1, it is difficult to grasp the update status of the learning data. With the technique described in Patent Document 2, it is necessary to save the learning model and the inference result into a database every time the learning model is updated, and therefore the operation cost increases.

### SUMMARY OF THE INVENTION

According to one aspect of the present invention, an information processing apparatus comprises: a model management unit that manages, in association with a first learning model, information on a second learning model used for creation of the first learning model and information on a first data set used for creation of the first learning model; a data management unit that manages, in association with the first data set, information on a second data set used for creation of the first data set; a detection unit that detects that a third learning model created by relearning on the second learning model has been added to a management target by the model management unit or that a third data set created by data manipulation on the second data set has been added to a management target by the data management unit; a setting unit that sets a notification condition for notifying that the third learning model or the third data set has been added; and a notification unit that performs notification if the notification condition set by the setting unit is satisfied.

The present invention facilitates acquisition of a learning model and learning data suitable for a user's purpose.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view illustrating a hardware configuration of a server apparatus.

FIG. 2 is a view illustrating a hardware configuration of a user apparatus.

FIG. 3 is a view illustrating an overall configuration of a system.

FIG. 4 is a view illustrating a functional configuration of the server apparatus.

FIGS. 5A and 5B are views illustrating examples of data management information and model management information.

FIG. 6 is a view illustrating an example of traceability information.

FIG. 7 is a view illustrating an example of notification information.

FIG. 8 is a flowchart of model/data registration and notification setting.

FIG. 9 is a flowchart of notification processing.

FIG. 10 is a view illustrating a functional configuration of the server apparatus (second embodiment).

FIG. 11 is a flowchart of model/data update and evaluation result notification.

FIG. 12 is a view illustrating an example of traceability information (second embodiment).

FIGS. 13A and 13B are views illustrating examples of a notification setting GUI.

FIG. 14 is a view illustrating a functional configuration of the server apparatus (third embodiment).

FIG. 15 is a flowchart of model/data update and relearning result notification.

FIG. 16 is a view illustrating an example of traceability information (third embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### FIRST EMBODIMENT

As the first embodiment of an information processing apparatus according to the present invention, a server apparatus that manages a learning model and learning data will be described below as an example.

### Outline

The server apparatus according to the present embodiment manages a model (learned model) and a data set together with traceability information (past update history of the model and the data set). When the model and the data set managed by the server apparatus are updated, the server apparatus notifies a target user that the update has been performed based on the notification setting registered in advance.

### Hardware Configurations of System and Apparatus

FIG. 3 is a view illustrating an overall configuration of the system. A server apparatus 10 is an information processing apparatus that operates as a server apparatus that manages a learning model and learning data. For example, it is arranged as a virtual server on a cloud server. User apparatuses 10 to 13 are information processing apparatuses that operate as user apparatuses that acquire the learning model and the learning data from the server apparatus and use the learning model and the learning data. As illustrated in FIG. 3, the virtual server is configured in such a manner that communication is possible with a plurality of user apparatuses, and is configured in such a manner that the user apparatuses can be provided with the learning model and the learning data in response to a request from the user apparatuses. The user apparatuses are terminal apparatuses with which a user browses and operates screens, and are, for example, a personal computer (PC) and a tablet terminal.

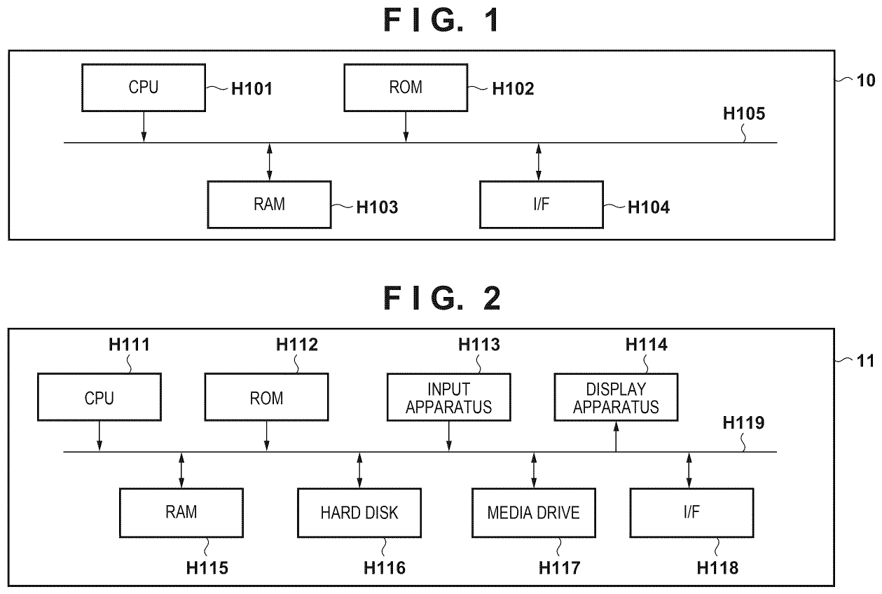

FIG. 1 is a view illustrating a hardware configuration of the server apparatus. An H101 is a CPU, and controls various devices connected to a system bus H105. An H102 is a ROM, and stores a basic input/output system (BIOS) program and a boot program. An H103 is a RAM, and is used as a main storage apparatus of the H101, which is a CPU. An H104 is an interface (I/F), and performs data communication with an external apparatus. For example, the interface may be a communication interface such as Ethernet (registered trademark), or may be a general-purpose interface such as USB or serial communication. The interface may be a wired connection interface or a wireless connection interface.

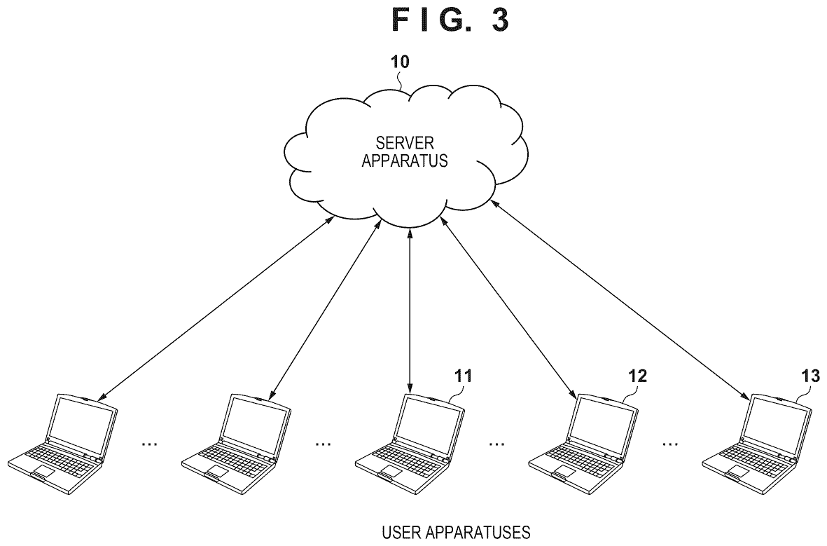

FIG. 2 is a view illustrating a hardware configuration of the user apparatus. An H111 is a CPU, and controls various devices connected to a system bus H119. An H112 is a ROM, and stores a BIOS program and a boot program. An H113 is an input apparatus, and performs processing related to input of various types of information. Examples thereof include a touch panel, a keyboard, a mouse, and a robot controller. An H114 is a display apparatus, and performs processing related to display of various types of information. For example, it displays a processing result processed by the user apparatus itself or a processing result processed by the server apparatus and transmitted to the user apparatus. Note that the display apparatus may be of any type, such as a liquid crystal display apparatus, a projector, or an LED indicator.

An H115 is a RAM, and is used as a main storage apparatus of the H111, which is a CPU. An H116 is a hard disk, and is used to store an application program, data, a library, and the like. An H117 is a media drive, and enables data writing/reading to/from a removable storage medium. Thereby, it enables data to be moved to an external apparatus (digital still camera, PC, and tablet terminal). An H118 is an interface (I/F), and performs data communication with an external apparatus. For example, the interface may be a communication interface such as Ethernet (registered trademark), or may be a general-purpose interface such as USB or serial communication. The interface may be a wired connection interface or a wireless connection interface.

### Task Processed by Machine Learning

As a case of the task handled in the first embodiment, an object detection task for inputting an image will be described here. The object detection task is a task of detecting a specific object in an image and inferring a bounding box (BB) surrounding the specific object when image data is input. However, the type of the task is not limited to object detection. For example, the present invention can be applied to various tasks such as a task of estimating and dividing a region and a classification task of classifying a subject (a person, a car, or the like).

### Functional Configuration of Server Apparatus

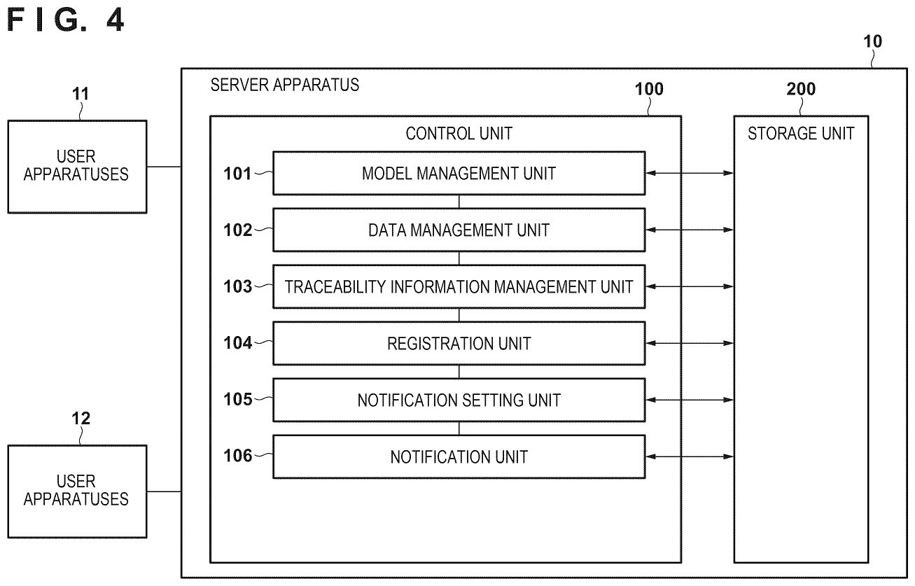

FIG. 4 is a view illustrating a functional configuration of the server apparatus. The server apparatus 10 includes a control unit 100 and a storage unit 200. Details of each configuration will be described below.

The control unit 100 includes a model management unit 101, a data management unit 102, a traceability information management unit 103, a registration unit 104, a notification setting unit 105, and a notification unit 106. Each of these functional units can be implemented, for example, by the CPU executing various programs. However, some or all of them may be implemented by hardware such as an application specific integrated circuit (ASIC).

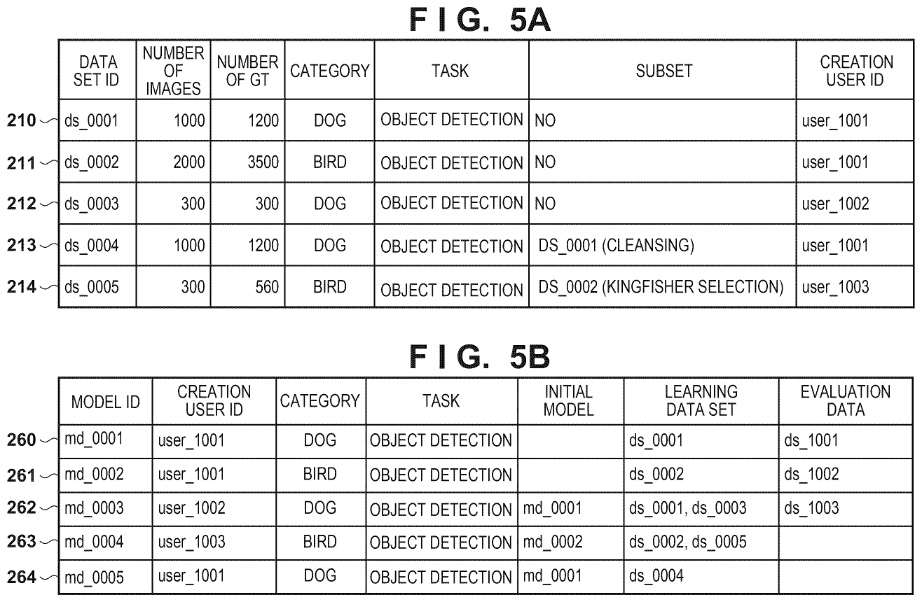

The model management unit 101 generates management information for a model (learned model), and manages the management information in association with the model. Information as illustrated in FIG. 5B is generated and applied to the model to be managed.

The “model ID” is model-specific identification information (ID). The “creation user ID” is ID of a user who performed learning of the model. The “category” is information on an object targeted by the model, information necessary for the user to search for the model, and the like. The “task” is a type of processing targeted by the model, such as object detection and image generation.

The “initial model” describes ID of a model that is an initial parameter at the time of learning the model. For example, as illustrated in FIG. 5B, the initial model for a model 262 is a model with a model ID “md_0001” and the model with the model ID “md_0001” is a model 260. That is, it is indicated that the model 262 is a model obtained as a result of (additional) learning with the model 260 as an initial model. The “learning data set” is ID of a data set used for learning the model. The “evaluation data” is ID of data used when the model is evaluated.

The data management unit 102 generates management information for a data set used for learning and evaluation, and manages the management information in association with the data set. Information as illustrated in FIG. 5A is generated and applied to the data set to be managed.

The “data set ID” (hereinafter written as “data ID”) is data set-specific ID. The “number of images” is the number of images held by the data set. The “number of GT” is the number of ground truth (GT) applied to the data set. The “category” is information on an object targeted by the data set or information necessary for the user to search for data. The “task” is a type of processing targeted by the data set, such as object detection and image generation.

The “subset” describes ID of a data set from which the data set is created. For example, as illustrated in FIG. 5A, the subset for a data set 213 is a data set with a data ID “ds_0002” and the model with the data ID “ds_0002” is a data set 211. That is, it is indicated that the data set 213 is a data set created based on the data set 211. The “creation user ID” is ID of a user who has created the data set.

The traceability information management unit 103 manages traceability information on the model and the data set. Here, the traceability information is information indicating how each model and data set to have been created in the past (i.e., past history of the model and the data set).

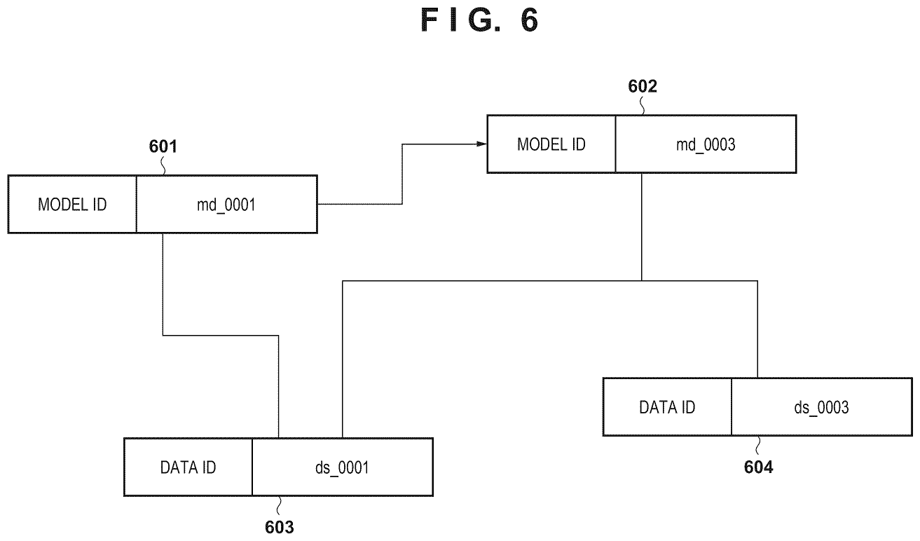

FIG. 6 is a view illustrating an example of traceability information. For example, it is indicated that a model 601 with the model ID “md_0001” is created by learning using the data set with the data ID “ds_0001”. It is indicated that a model 602 with a model ID “md_0002” is created by learning using the data set with the data ID “ds_0001” and a data set with a data ID “ds_0003”, of the model ID “md_0001” as an initial model.

These pieces of traceability information are created based on the model management information and the data management information described above. As described above, the traceability information indicates the past history of each model and data set. Therefore, by referring to the traceability information, it is possible to extract information regarding the model and the data set used for creation of each model and data set.

The registration unit 104 registers, updates, and deletes the model and the data set. When the registration unit 104 registers, updates, and deletes the model or the data set, the traceability information management unit 103 updates the traceability information. That is, the traceability information management unit 103 updates the traceability information based on the model management information and the data management information related to the registered, updated, and deleted model and data set.

The notification setting unit 105 sets notification information requested by the user.

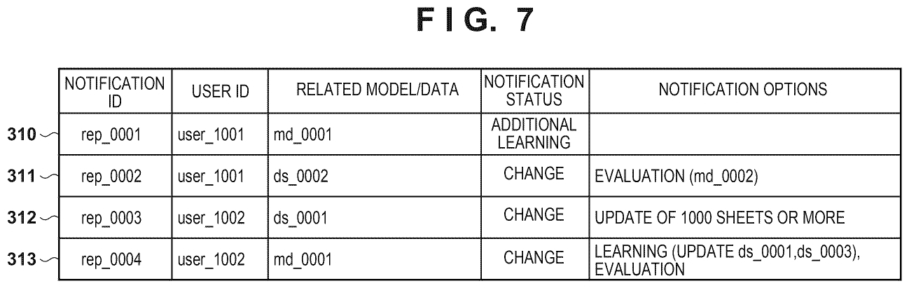

FIG. 7 is a view illustrating an example of notification information. The “notification ID” is notification-specific ID. The “user ID” describes the ID of a user who has set the notification information or the user who is a transmission destination of the notification information. The “related model/data” describes model ID of a model or data ID of a data set related to the notification information.

The “notification status” describes a status (e.g., data change) in which notification of notification information is made. For example, notification information 310 with notification ID “rep_0001” is notification information set by the user of user ID “user_1001”, and it is indicated that the notification information 310 is notified when a model additionally learned for the model ID “md_0001” is registered. The “notification option” is for setting an option (e.g., detailed condition setting of the notification status) included in the notification.

The notification unit 106 generates notification content based on the traceability information and the notification information set by the notification setting unit 105 and notifies the user of the notification content. Details of a procedure for generating the notification content will be described later with reference to FIG. 9.

### Apparatus Operation

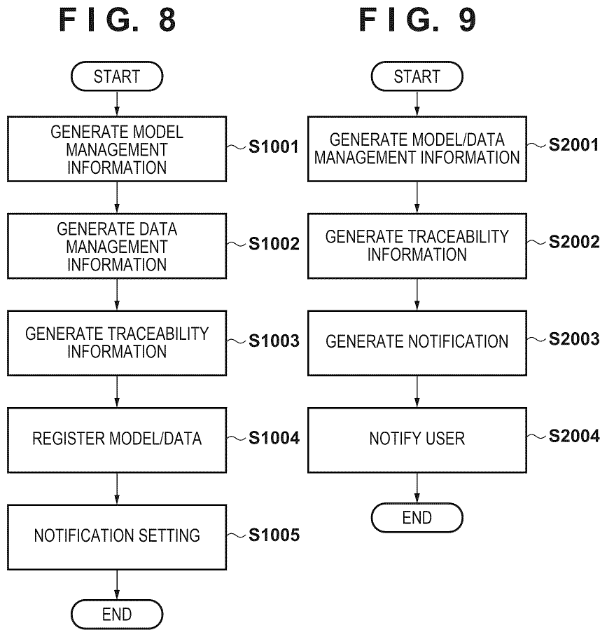

FIG. 8 is a flowchart of registration of a model and data and notification setting. Here, a case where a certain user collects a dog image and creates and registers a dog detection model is assumed. However, the server apparatus 10 needs not necessarily perform all the steps described in this flowchart. The image is not limited to the dog, and may be a person, a car, or the like that is a detection target, and the detection model is not limited to the dog detection. The flowchart of FIG. 8 is started when the user (user 1) registers (transmits), to the server apparatus 10, the dog detection model and the dog image data created by operating the user apparatus 10.

In S1001, the model management unit 101 generates model management information on the dog detection model transmitted from the user. Here, the model management information on the model 260 illustrated in FIG. 5B is created as the model management information on the dog detection model. In the model management information, the model ID “md_0001” is applied, and the creation user ID “user_1001”, the category “dog”, and the task “object detection” are registered. There is no registration of the initial model, and the learning data set describes the data ID “ds_0001” of the data set registered together with the model. Here, the data ID “ds_1001” is described as a data set used as evaluation data.

In S1002, the data management unit 102 generates data management information on the data set of the dog image transmitted from the user. Here, data management information on a data set 210 illustrated in FIG. 5A is created as the data management information on the dog image data. In the data management information, the data ID “ds_0001” is applied, and the number of images “1000”, the number of GT “1200”, the category “dog”, and the task “object detection” are registered. Here, it is assumed that the data included in the data set to be registered is created/collected by the user 1 himself. Therefore, since there is no data associated with the data set, “none” or a blank is registered in the subset. Then, the creation user ID describes the user ID “user_1001” of the user 1.

In S1003, the traceability information management unit 103 generates traceability information. Here, traceability information indicated in the model 601 and data 603 (corresponding to the dog detection model and the dog image data) of FIG. 6 is generated. From the generated traceability information, it is indicated that the model 601 of the model ID “md_0001” is created using the data set of the data ID “ds_0001” as learning data.

In S1004, the registration unit 104 registers the dog detection model and the dog image data transmitted from the user.

In S1005, the notification setting unit 105 sets notification information requested by the user. Here, the notification information 310 of FIG. 7 is set as the notification setting set by the user 1. That is, the user 1 assumes a status of “desiring to receive a notification when another user uses the dog detection model registered by himself as an initial model and registers a new detection model”.

Here, the notification setting 310 is applied with the notification ID “rep_0001”, the user ID describes “user_1001”, and the related model/data describes “md_0001”. The “additional learning” is designated in the notification status.

Through the above processing procedure, registration of the learning model and the learning data and notification setting are performed. Although an example of collectively performing registration of the model and the data and notification setting has been described here, registration of only the model, registration of only the data, or only setting of notification may be performed.

FIG. 9 is a flowchart of the notification processing. Specifically, it is a processing procedure for notifying the user when the model or data saved in the server apparatus 10 is updated. Here, a status in which a user 2 creates an updated dog detection model and dog data using the dog detection model and the dog data described in FIG. 8 is assumed. More specifically, the user 2 creates a data set (Chihuahua image data) including an image of “Chihuahua” that is his own pet, and additionally learns (relearns) the dog detection model to create a “Chihuahua detection model”. The flowchart of FIG. 9 is started when the user (user 2) registers (transmits), to the server apparatus 10, the Chihuahua detection model and the Chihuahua image data created by operating the user apparatus 12.

In S2001, the model management unit 101 generates model management information on the Chihuahua detection model transmitted from the user, and the data management unit 102 generates data management information on the Chihuahua image data transmitted from the user.

Here, the model management information on the model 262 illustrated in FIG. 5B is created as the model management information on the Chihuahua detection model. In the model management information, model ID “md_0003” is applied, the model ID “md_0001” is described as an initial model, and the data ID “ds_0001” and “ds_0003” are described in the learning data set.

Data management information on a data set 212 illustrated in FIG. 5A is created as data management information on the Chihuahua image data. In the data management information, the data ID “ds_0003” is applied, and the number of images “300”, the number of GT “300”, the category “dog”, and the task “object detection” are registered. Here, it is assumed that the data included in the data set to be registered is created/collected by the user 2 himself. Therefore, since there is no data associated with the data set, “none” or a blank is registered in the subset. Then, the creation user ID describes the user ID “user_1002” of the user 2.

In S2002, the traceability information management unit 103 generates traceability information from the model management information and the data management information generated in S2001. Here, traceability information indicated in the model 602 and data 604 (corresponding to the Chihuahua detection model and the Chihuahua image data) of FIG. 6 is generated. From the generated traceability information, it is indicated that the model 602 of the model ID “md_0003” is created using the data sets of the data ID “ds_0001” and “ds_0003” as learning data. That is, it is detected that the model 602 created by relearning of the model 601 has been added to the management target.

In S2003, the notification unit 106 generates a notification based on the traceability information generated in S2002 and the notification information (FIG. 7) set by the notification setting unit 105. In the notification information 310, it is set to notify the user 1 of the user ID “user_1001” when the model of the model ID “md_0001” is additionally learned. Since the above-described Chihuahua detection model (model ID “md_0003”) is created using the model of the model ID “md_0001” as an initial model, the notification is generated.

In S2004, the notification unit 106 notifies the user of the notification generated in S2003. In the example of the generated notification, the user 1 (e.g., the user apparatus 11) is notified that the model of the model ID “md_0003”, which is a relearning model using the model of the model ID “md_0001” as an initial model, has been registered.

The above-described processing enables the user 1 to easily know that the dog detection model (model ID “md_0001”) created by himself has been relearned by the user 2 and the Chihuahua detection model (model ID “md_0003”) has been created.

While in the example of FIG. 9 described above, the notification in a case where the model is updated (relearned) is described, the notification may be made in a case where data is updated. For example, the user 2 assumes a status of desiring to receive a notification when the data set of the data ID “ds_0001” used when the Chihuahua detection model was created is changed is assumed. Here, it is assumed that the user ID, the model ID, the related model/data, the notification status, and the notification option indicated in the notification information 312 of FIG. 7 are set. Here, “update of 1000 sheets or more (of data)” is set as a notification option. Note that a setting that the notification is made by a change of one sheet may be set, but the notification is made by a change of a certain number of sheets or more may be set so that the frequency of the notification is not excessive.

It is assumed that the user 1 modifies (cleanses) the GT of the data set of the data ID “ds_0001”. When registering the cleansed data, the user 1 writes a subset “ds_0001 (cleansing)” as the data set 213 of FIG. 5A, and registers that the data set is based on the data set of the data ID “ds_0001”. By this, the notification setting unit 105 generates a notification based on the notification information 312 in FIG. 7 and the data management information on the data set 213 of FIG. 5A. Specifically, the user 2 is notified that there has been a change in the data set of the data ID “ds_0001”.

The above-described processing enables the user 2 to easily know that there has been a change in the data set used when the Chihuahua detection model was created. Since it is possible to know that cleansing has been performed on the data set, it is possible to obtain an opportunity to relearn the model and improve the accuracy.

Other examples of the notification status include an increase in the number of images included in the data set and new addition of the task. In the case of dog image data, a setting may be made such that a notification is obtained when new dog image data is registered. Furthermore, it is also conceivable to notify information on an inclusion relationship of data such as “a data set in which an image of a kingfisher in particularly is selected from bird image data has been created” as notification content.

As described above, according to the first embodiment, when the model and the data set managed by the server apparatus are updated, the server apparatus notifies a target user that the update has been performed based on the notification setting registered in advance. This enables the user to easily grasp the learning model and the learning data suitable for use and the update status thereof. It is possible for the user to appropriately grasp that learning data having a possibility of improving the learning model has been created.

### SECOND EMBODIMENT

In the second embodiment, a notification operation in a case where a data set created by the user 1 is edited by a user 3 and the edited data set is registered by the user 3 will be described. In particular, a form of evaluating the edited data set and notifying the user 1 will be described.

In the second embodiment, a description is made on an assumption that the user 1 has registered and saved in advance a bird detection model (model ID “md_0002”) and bird image data (data ID “ds_0002”) into the server apparatus 10.

### Apparatus Configuration

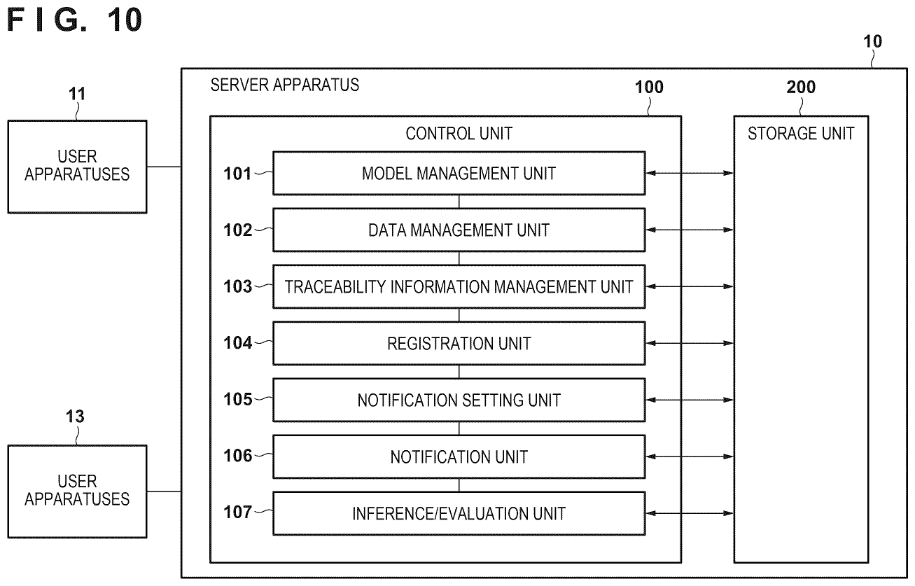

FIG. 10 is a view illustrating a functional configuration of the server apparatus in the second embodiment. The functional configuration is substantially the same as that of the first embodiment (FIG. 4), but is different in further including an inference/evaluation unit 107. Note that the user apparatus 13 is assumed to be a terminal operated by the user 3.

The inference/evaluation unit 107 is a functional unit that performs inference/evaluation based on a learning model and learning data designated by the notification setting unit 105. The inference/evaluation result is sent to the notification unit 106.

### Notification Setting Graphical User Interface (GUI)

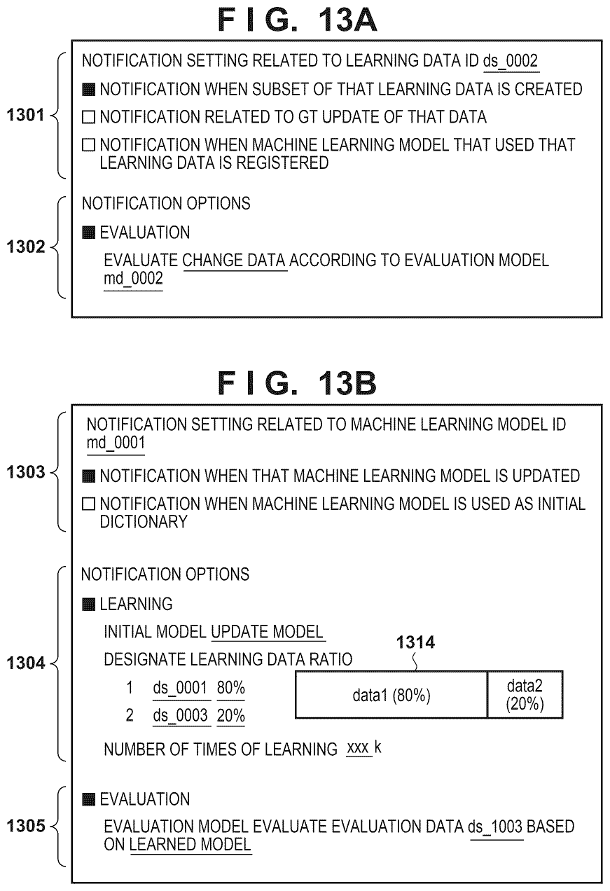

FIG. 13A is a view illustrating an example of a notification setting GUI related to learning data. Specifically, it is a GUI displayed on the display unit of the user apparatus 11 for the user 1 to set a notification condition regarding the bird image data (data ID “ds_0002”).

Here, it is assumed that the user 1 desires to examine whether or not use of update learning data is useful for learning of the model of himself when the update learning data based on the bird image data created by himself is created. Therefore, when the learning data based on the data of the data ID “ds_0002” is registered, setting is performed such that a notification is given to himself.

A setting item 1301 is an item for setting a status to be notified, and three items are indicated here. The first is a setting in which a notification is made when a subset of the target data set is created. The second is a setting in which a notification is made when a data set in which the GT of the target data set is changed or added is created. The third is a setting in which a notification is made when the learning model using the target data set is registered. In FIG. 13A, a setting that a notification is made when a subset of the target data set is created is made (the first check box is selected and blackened).

A setting item 1302 is to set an option included in the notification. Here, whether or not to include an evaluation result in notification content can be set. In FIG. 13A, a setting that an evaluation result is included in notification content is made. Note that in a case where evaluation is performed, it is necessary to set a target learning model and evaluation data to be used for evaluation, and therefore the learning model and the evaluation data can be further designated. In FIG. 13A, as the learning model, a bird detection model (model ID “md_0002”), which is the learning model used at the time of learning of the data of the data ID “ds_0002”, is designated. As the evaluation data, “change data” created based on the data of the data ID “ds_0002” is designated.

The notification setting GUI by FIG. 13A is an example, and the item is not limited to the check box and may be another method such as pull down. More setting items may be added (e.g., data is divided or integrated). Alternatively, the setting items may be configured as more rough setting items.

### Apparatus Operation

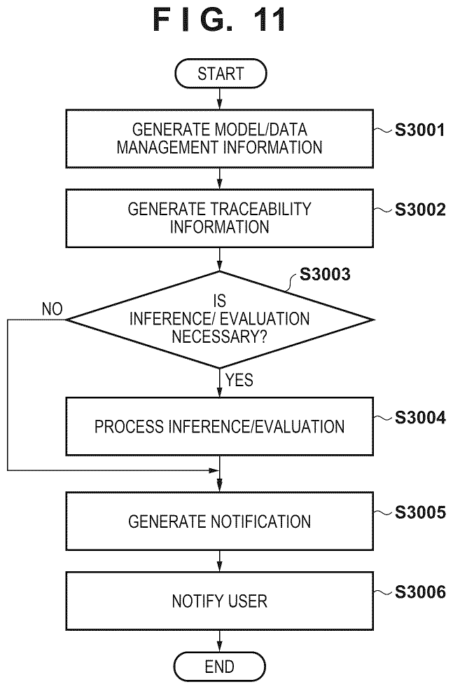

FIG. 11 is a flowchart of model/data update and evaluation result notification. Specifically, it is a processing procedure of notifying the user 1 when an update is made to the model or data created by the user 1 saved in the server apparatus 10.

Here, it is assumed that the user 3 desires to create a kingfisher detection model based on the bird detection model and the bird learning data created by the user 1. Therefore, it is assumed that using the user apparatus 13, the user 3 has extracted only a kingfisher image from the bird image data (data ID “ds_0002”) and created kingfisher image data. Furthermore, it is assumed that using the bird detection model (model ID “md_0002”) as an initial model, additional learning using the kingfisher image data is performed, and the kingfisher detection model is created. The flowchart of FIG. 11 is started when the user (user 3) registers (transmits), to the server apparatus 10, the kingfisher detection model and the kingfisher image data created by operating the user apparatus 13. Note that the detection model and the learning data are not limited to the bird, and may be a person, a car, or the like, and the learning model is not limited to the detection model.

In S3001, the model management unit 101 generates model management information on the kingfisher detection model transmitted from the user, and the data management unit 102 generates data management information on the kingfisher image data transmitted from the user.

Here, the model management information on a model 263 illustrated in FIG. 5B is created as the model management information on the kingfisher detection model. In the model management information, model ID “md_0004” is applied, the model ID “md_0002” is described as an initial model, and the data ID “ds_0002” and “ds_0005” are described in the learning data set.

Data management information on a data set 214 illustrated in FIG. 5A is created as data management information on the kingfisher image data. In the data management information, the data ID “ds_0005” is applied, and the number of images “300”, the number of GT “560”, the category “bird”, and the task “object detection” are registered. Here, since the image data included in the kingfisher image data to be registered was selected from the bird image data (data ID “ds_0002”), the subset describes “ds_0002”. Then, the creation user ID describes the user ID “user_1003” of the user 3.

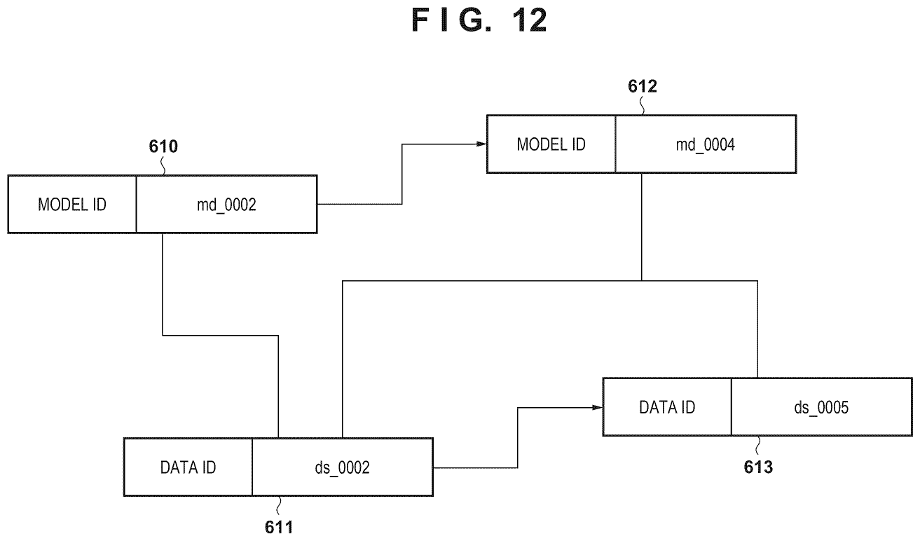

In S3002, the traceability information management unit 103 generates traceability information from the model management information and the data management information generated in S3001. Here, traceability information indicated in a model 612 and data 613 (corresponding to the kingfisher detection model and the kingfisher image data) of FIG. 12 is generated.

FIG. 12 is a view illustrating an example of traceability information in the second embodiment. Note that a model 610 (model ID “md_0002”) and data 611 (data ID “ds_0002”) correspond to the bird detection model and the bird image data created and registered by the user 1. From the generated traceability information, it is indicated that the model 612 of the model ID “md_0004” is created using the model 610 of the model ID “md_0002” as an initial model. It is indicated to be created using the data sets of the data ID “ds_0002” and “ds_0005” as learning data. Furthermore, it is indicated that the data set of the data ID “ds_0005” is created based on the data set of the data ID “ds_0002”. That is, it is detected that the data set created by the data manipulation on the data set of the data ID “ds_0002” has been added to the management target.

In S3003, the notification unit 106 determines whether or not evaluation processing by the inference/evaluation unit 107 is necessary based on the traceability information generated in S3002 and the notification information (FIG. 7) set by the notification setting unit 105. The notification setting set by the user 1 described with reference to FIG. 13A corresponds to a notification setting 311 of FIG. 7. Here, since the data of the data ID “ds_0005” has been created based on the data of the data ID “ds_0002”, it is determined that the notification status indicated by the notification setting 311 is satisfied. Since “evaluation” is set in the notification option indicated in the notification setting 311, it is determined that evaluation is necessary, and the process proceeds to S3004. Note that when it is determined that evaluation is not necessary, such as when “evaluation” is not set in the notification option, the process proceeds to S3005.

In S3004, the inference/evaluation unit 107 executes inference/evaluation using the model of the model ID “md_0002” and the data of the data ID “ds_0005”. The model and data used here are designated in the setting item 1302 of FIG. 13A. The inference/evaluation result is sent to the notification unit 106.

In S3005, the notification unit 106 generates a notification including the evaluation result by S3004 in the notification based on the notification information (FIG. 7). In S3006, the notification unit 106 notifies the user 1 of the notification generated in S3005.

The above-described processing enables the user 1 to easily know that the kingfisher image data based on the bird detection model (model ID “md_0002”) created by himself has been created and registered. Furthermore, based on the evaluation result included in the notification, the user 1 can obtain an inference/evaluation result by the bird detection model (model ID “md_0002”) of himself and the created kingfisher image data. For example, the user 1 can easily know the accuracy of the bird detection model of himself with respect to the kingfisher image data (update learning data). Therefore, it is possible to examine whether or not use of update learning data is useful for learning of the model of himself.

As described above, according to the second embodiment, when the model and the data set managed by the server apparatus are updated, the server apparatus notifies a target user that, together with the evaluation result, the update has been performed based on the notification setting registered in advance. This enables the user to easily grasp whether or not the derivatives of the learning model and the learning data created by himself are useful for himself.

### THIRD EMBODIMENT

In the third embodiment, a notification operation in a case where an initial model used when the user 2 performed additional learning of a learning model is updated will be described. In particular, a form of relearning the updated initial model and notifying the user 2 will be described.

In the third embodiment, a description is made on an assumption that the user 1 has registered and saved in advance the dog detection model (model ID “md_0001”) and dog image data (data ID “ds_0001”) into the server apparatus 10. The user 2 performs relearning using the dog detection model created by the user 1 as an initial model, and performs registration of the relearned model and notification setting.

### Apparatus Configuration

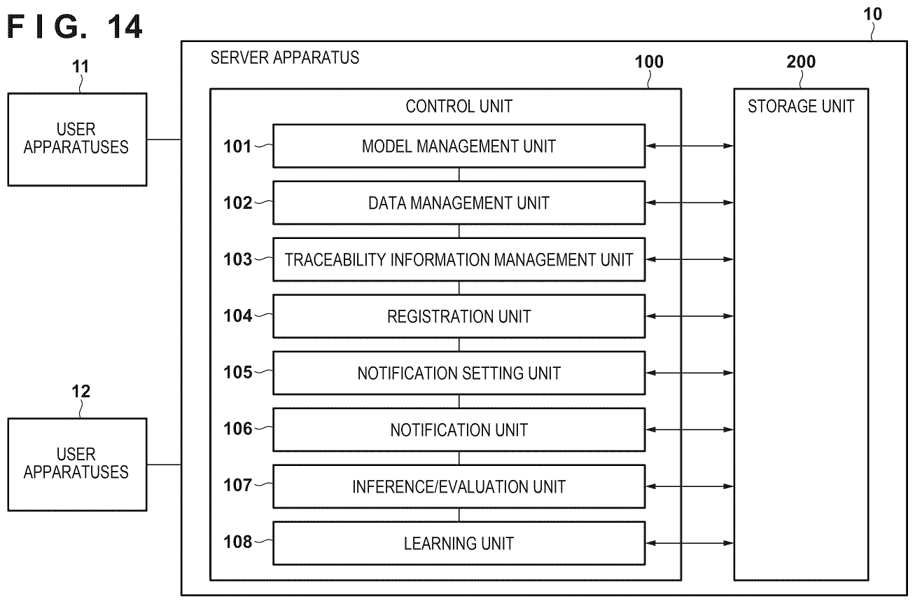

FIG. 14 is a view illustrating a functional configuration of the server apparatus in the third embodiment. The functional configuration is substantially the same as that of the first embodiment (FIG. 4), but is different in further including the inference/evaluation unit 107 and a learning unit 108. Note that the inference/evaluation unit 107 is the same as that of the second embodiment.

The learning unit 108 is a functional unit that performs relearning based on the learning model and the learning data designated by the notification setting unit 105. The learning result is sent to the notification unit 106.

### Notification Setting Graphical User Interface (GUI)

In FIG. 13B is a view illustrating an example of a notification setting GUI related to the learning model. Specifically, it is a GUI displayed on the display unit of the user apparatus 12 for the user 2 to set a notification condition related to the dog detection model (model ID “md_0001”). Here, it is assumed that the user 2 desires to perform relearning again when the dog detection model (model ID “md_0001”) used for relearning (additional learning) is updated.

A setting item 1303 is an item for setting a notification status related to the learning model, and two items are indicated here. As described above, the dog detection model (model ID “md_0001”) is targeted here. The first is a setting in which a notification is made when the target learning model is updated. The second is a setting in which a notification is made when the target learning model is used as an initial model, and a new model is registered. In FIG. 13B, a setting that a notification is made when the target learning model is updated is made (the first check box is selected and blackened).

A setting item 1304 is to set an option included in the notification, and here, it is set whether or not to include the learning result in the notification content. In FIG. 13B, a setting that a learning result is included in notification content is made. Note that in a case of performing learning, it is necessary to set a target learning model and learning data used for learning. In FIG. 13B, as the initial model, an “update model” to be a notification target is designated. Two types of learning data are designated, and a ratio thereof is also designated. The ratio may be designated by a numerical value or may be designated by an intuitively understandable method such as a view, a graph, or a table as in a graph 1314.

A setting item 1305 is to set whether or not to include an evaluation result in notification content. This is the same as that of the second embodiment, and thus description thereof is omitted.

The notification setting GUI by FIG. 13B is an example, and the item is not limited to the check box and may be another method such as pull down. For the learning data ratio and the like, a selection option may be presented and designation may be received from the user.

### Apparatus Operation

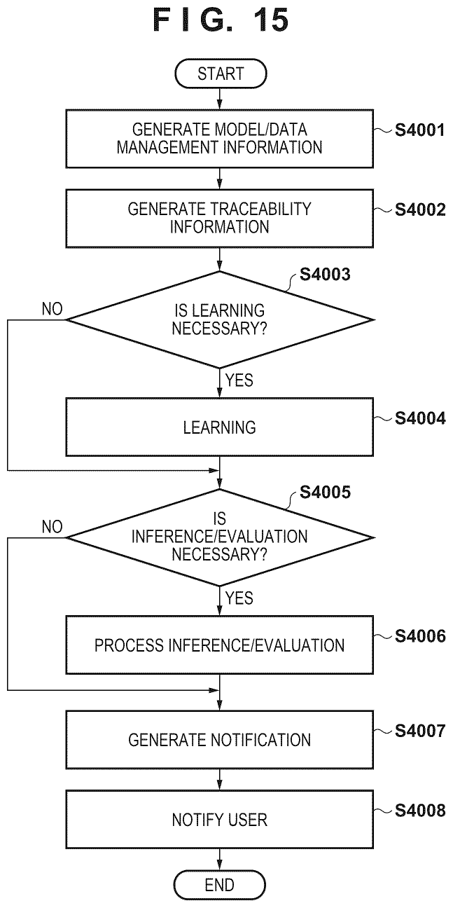

FIG. 15 is a flowchart of model/data update and relearning result notification. The flowchart of FIG. 11 is started when the user 1 relearns the dog detection model created by himself, creates a new dog detection model, and registers (transmits) the new dog detection model to the server apparatus 10.

In S4001, the model management unit 101 generates model management information on the new dog detection model transmitted from the user, and the data management unit 102 generates data management information on the dog image data transmitted from the user.

Here, the model management information on a model 264 illustrated in FIG. 5B is created as the model management information on the dog detection model. In the model management information, model ID “md_0005” is applied, and the model ID “md_0001” is described as an initial model.

Data management information on a data set 213 illustrated in FIG. 5A is created as data management information on the dog image data. In the data management information, data ID “ds_0004” is applied and registered. Here, it is described that the dog image data (data ID “ds_0004”) to be registered is created based on the data set “ds_0001”.

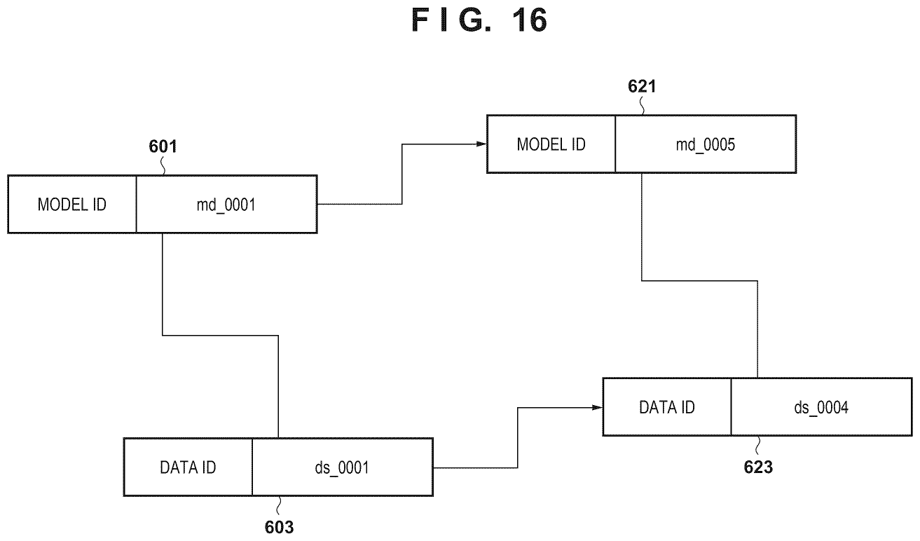

In S4002, the traceability information management unit 103 generates traceability information from the model management information and the data management information generated in S4001. Here, traceability information indicated in a model 621 and data 623 (corresponding to the new dog detection model and the dog image data) of FIG. 16 is generated.

FIG. 16 is a view illustrating an example of traceability information in the third embodiment. Note that the model 601 (model ID “md_0001”) and the data 603 (data ID “ds_0001”) correspond to the dog detection model and the dog image data created and registered by the user 1 in the past. From the generated traceability information, it is indicated that the model 621 of the model ID “md_0005” is created using the model 601 of the model ID “md_0001” as an initial model. It is indicated to be created using the data set of the data ID “ds_0004” as learning data. Furthermore, it is indicated that the data set of the data ID “ds_0004” is created based on the data set of the data ID “ds_0001”.

In S4003, the notification unit 106 determines whether or not learning processing by the learning unit 108 is necessary based on the traceability information generated in S4002 and the notification information (FIG. 7) set by the notification setting unit 105. The notification setting set by user 2 described with reference to FIG. 13B corresponds to notification setting 313 of FIG. 7. Here, since the model of the model ID “md_0005” has been created based on the model of the model ID “md_0001”, it is determined that the notification status indicated by the notification setting 313 is satisfied. Since “learning” is set in the notification option indicated in the notification setting 313, it is determined that learning is necessary, and the process proceeds to S4004. Note that when it is determined that learning is not necessary, such as when “learning” is not set in the notification option, the process proceeds to S4005.

In S4004, the learning unit 108 executes learning processing a designated number of times using the model of the model ID “md_0005” and the data of the data ID “ds_0001” (80%) and “ds_0003” (20%). The model, the data, the ratio, and the number of times of learning used here are designated by the setting item 1304 of FIG. 13B. The learning result is sent to the notification unit 106.

In S4005, the notification unit 106 determines whether or not evaluation processing by the inference/evaluation unit 107 is necessary based on the notification information (FIG. 7) set by the notification setting unit 105. The notification setting set by user 2 described with reference to FIG. 13B corresponds to notification setting 313 of FIG. 7. Since “evaluation” is set in the notification option indicated in the notification setting 313, it is determined that evaluation is necessary, and the process proceeds to S4006. Note that when it is determined that evaluation is not necessary, such as when “evaluation” is not set in the notification option, the process proceeds to S4007.

In S4006, the inference/evaluation unit 107 executes inference/evaluation using the “learned model” obtained by the learning of S4004 and the data of the data ID “ds_1003”. The model and the data used here are designated in the setting item 1305 of FIG. 13B. The inference/evaluation result is sent to the notification unit 106.

In S4007, the notification unit 106 generates a notification including the learning result by S4004 and the evaluation result by S4006 in the notification based on the notification information (FIG. 7). In S4008, the notification unit 106 notifies the user 2 of the notification generated in S4007.

The above-described processing enables the user 2 to easily know that the learning model used as the initial model has been updated. Furthermore, the user 2 can easily know what feature the updated model has based on the learning result and the evaluation result included in the notification.

As described above, according to the third embodiment, when the model and the data set managed by the server apparatus are updated, the server apparatus notifies a target user that, together with the evaluation result, the update has been performed based on the notification setting registered in advance. This enables the user to easily grasp what feature the learning model created by himself has come to have by the update.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070814, filed Apr. 24, 2024 which is hereby incorporated by reference herein in its entirety.

What is claimed is:

1. An information processing apparatus comprising:
a model management unit that manages, in association with a first learning model, information on a second learning model used for creation of the first learning model and information on a first data set used for creation of the first learning model;
a data management unit that manages, in association with the first data set, information on a second data set used for creation of the first data set;
a detection unit that detects that a third learning model created by relearning on the second learning model has been added to a management target by the model management unit or that a third data set created by data manipulation on the second data set has been added to a management target by the data management unit;
a setting unit that sets a notification condition for notifying that the third learning model or the third data set has been added; and
a notification unit that performs notification if the notification condition set by the setting unit is satisfied.

2. The information processing apparatus according to claim 1, wherein
a first user who has created the first learning model and a second user who has created the second learning model are different from each other, and
the notification unit performs the notification to the second user.

3. The information processing apparatus according to claim 1, wherein
the third data set is a data set created by performing, on the second data set, the data manipulation of at least one of addition of data, deletion of data, modification of data, addition of ground truth (GT), deletion of GT, and modification of GT.

4. The information processing apparatus according to claim 1, wherein
the setting unit includes a condition related to the data manipulation as a first notification condition for notifying that the third data set has been added.

5. The information processing apparatus according to claim 1 further comprising:
an evaluation unit that performs evaluation of a designated learning model based on the learning model and a data set,
wherein the setting unit can further set as to whether or not to perform evaluation by the evaluation unit, and
the notification unit includes, in the notification, an evaluation result by the evaluation unit in a case where the setting unit has set performing of the evaluation.

6. The information processing apparatus according to claim 5, wherein
the setting unit can further designate a learning model and a data set to be used for the evaluation.

7. The information processing apparatus according to claim 5 further comprising:
a learning unit that performs learning of a designated learning model based on the learning model and a data set,
wherein the setting unit can further set as to whether or not to perform learning by the learning unit, and
the notification unit includes, in the notification, a learning result by the learning unit in a case where the setting unit has set performing of the learning.

8. The information processing apparatus according to claim 7, wherein
the setting unit can further designate a learning model and a data set to be used for the learning.

9. The information processing apparatus according to claim 1, wherein
the setting unit receives a setting related to the notification condition via a graphical user interface (GUI) displayed on a display unit of a terminal operated by a user.

10. A control method of an information processing apparatus, wherein
the information processing apparatus comprises:
a model management unit that manages, in association with a first learning model, information on a second learning model used for creation of the first learning model and information on a first data set used for creation of the first learning model, and
a data management unit that manages, in association with the first data set, information on a second data set used for creation of the first data set,
the control method comprising:
detecting that a third learning model created by relearning on the second learning model has been added to a management target by the model management unit or that a third data set created by data manipulation on the second data set has been added to a management target by the data management unit,
setting a notification condition for notifying that the third learning model or the third data set has been added, and
performing notification if the notification condition set by the setting is satisfied.

11. A non-transitory computer-readable recording medium storing a program that, when executed by a computer, causes the computer to perform a control method of an information processing apparatus, wherein
the information processing apparatus comprises:
a model management unit that manages, in association with a first learning model, information on a second learning model used for creation of the first learning model and information on a first data set used for creation of the first learning model, and
a data management unit that manages, in association with the first data set, information on a second data set used for creation of the first data set,
the control method comprising:
detecting that a third learning model created by relearning on the second learning model has been added to a management target by the model management unit or that a third data set created by data manipulation on the second data set has been added to a management target by the data management unit,
setting a notification condition for notifying that the third learning model or the third data set has been added, and
performing notification if the notification condition set by the setting is satisfied.
